(19) United States
(12) Patent Application Publication
(10) Pub. No.: US 2023/0005478 A1
(43) Pub. Date: Jan. 5, 2023

(54) INFORMATION PROCESSING APPARATUS, INFORMATION PROCESSING SYSTEM, AND INFORMATION PROCESSING METHOD

(71) Applicant: TOYOTA JIDOSHA KABUSHIKI KAISHA, Toyota-shi (JP)

(72) Inventor: Koki MORI, Inuyama-shi (JP)

(73) Assignee: TOYOTA JIDOSHA KABUSHIKI KAISHA, Toyota-shi (JP)

(21) Appl. No.: 17/850,355

(22) Filed: Jun. 27, 2022

(30) Foreign Application Priority Data
Jun. 30, 2021 (JP) 2021-108897

(51) Int. Cl. G10L 15/22; G10L 15/00; G10L 15/30

(52) U.S. Cl. CPC G10L 15/22; G10L 15/005; G10L 15/30; G01C 21/3629

(57) ABSTRACT

An information processing apparatus comprises a controller configured to: give a speech guidance to a user using first speech data corresponding to a first language;
determine that the user utilizes a language different from the first language; and acquire second speech data corresponding to the language to be utilized by the user on a basis of a result of the determination.

### CROSS REFERENCE TO THE RELATED APPLICATION

This application claims the benefit of Japanese Patent Application No. 2021-108897, filed on Jun. 30, 2021, which is hereby incorporated by reference herein in its entirety.

### BACKGROUND

### Technical Field

The present disclosure relates to an apparatus that provides information.

### Description of the Related Art

A system that provides information by an in-vehicle computer is in widespread use.

Concerning this, for example, Japanese Patent Laid-Open No. 2008-026653 discloses an invention related to a navigation apparatus that outputs a guidance through a speech and visual information.

### SUMMARY

The present disclosure is directed to reducing cost of an apparatus that gives a speech guidance.

The present disclosure in its one aspect provides an information processing apparatus comprising a controller configured to: give a speech guidance to a user using first speech data corresponding to a first language; determine that the user utilizes a language different from the first language; and acquire second speech data corresponding to the language to be utilized by the user on a basis of a result of the determination.

The present disclosure in its another aspect provides an information processing system comprising a first apparatus that gives a speech guidance to a user and a second apparatus that provides speech data to be used for the speech guidance, wherein the first apparatus comprises a controller configured to: give a speech guidance to the user using first speech data corresponding to a first language; determine that the user utilizes a language different from the first language; and acquire second speech data corresponding to the language to be utilized by the user from the second apparatus on a basis of a result of the determination.

The present disclosure in its another aspect provides an information processing method comprising: a step of giving a speech guidance to a user using first speech data corresponding to a first language; a step of determining that the user utilizes a language different from the first language; and a step of acquiring second speech data corresponding to the language to be utilized by the user on a basis of a result of the determination.

According to the present disclosure, it is possible to reduce cost of an apparatus that gives a speech guidance.

### BRIEF DESCRIPTION OF THE DRAWINGS

FIG. 1 is a schematic view of a vehicle system according to a first embodiment;

FIG. 2 is a view for explaining components of a vehicle according to the first embodiment;

FIG. 3 is a schematic view for explaining functional modules of a controller and data stored in a storage;

FIG. 4 is an example of a data set stored in the storage;

FIG. 5 is a schematic view of a server apparatus in the first embodiment;

FIG. 6 is an example of a speech database stored in the server apparatus;

FIG. 7 is a flowchart of processing in the first embodiment;

FIG. 8 is an example of a screen on which language setting is performed;

FIG. 9 is a flowchart of processing in a second embodiment;

FIG. 10 is an example of a screen on which language setting is suggested; and

FIG. 11 is an example of speech data to be generated by a server apparatus in a third embodiment.

### DESCRIPTION OF THE EMBODIMENTS

In recent years, an automobile that can be connected to a network has been in widespread use. By an in-vehicle device providing network connection, a service that performs support in an emergency and a service related to security can be provided. Such a device is also called a data communication module (DCM). Further, a DCM that can give a speech guidance using speech data set in advance is known.

However, in a case where vehicles are sold across a plurality of countries and regions, a problem can arise that a language that a user desires to use does not match a language of speech data set in advance in the apparatus. While it is also possible to hold speech data corresponding to all languages in advance and make the speech data selectable, another problem arises that manufacturing cost of the apparatus increases.

The information processing apparatus according to the present disclosure solves such a problem.

An information processing apparatus according to one aspect of the present disclosure includes a controller configured to give a speech guidance to a user using first speech data corresponding to a first language, determine that the user utilizes a language different from the first language and acquire second speech data corresponding to the language to be utilized by the user on the basis of a result of the determination.

While the information processing apparatus is typically an apparatus mounted on a vehicle, the information processing apparatus is not limited to this. The first speech data can be made, for example, a set of a plurality of pieces of speech data stored in advance in the apparatus. The controller gives a speech guidance to the user using the first speech data and determines that the user utilizes a language different from the first language.

The language to be utilized by the user may be acquired, for example, via another device mounted on the vehicle. For example, in a case where another device (such as, for example, a car navigation device) that can be utilized as a user interface is mounted on the vehicle, designation of the language may be accepted via the device. Further, in a case where a speech input device is mounted on the vehicle, the language to be utilized by the user may be determined on the basis of a speech made by the user. In this manner, the information processing apparatus according to the present disclosure does not necessarily have to include an input device for designating the language.

The controller acquires the second speech data corresponding to the language to be utilized by the user on the basis of the result of the determination. The second speech data may be acquired, for example, from an external apparatus that provides speech data via a network.

The controller switches the language, for example, by overwriting the first speech data with the acquired second speech data.

Specific embodiments of the present disclosure will be described below on the basis of the drawings. Hardware configurations, module configurations, functional configurations, and the like, described in the embodiments are not intended to limit the technical scope of the disclosure unless otherwise described.

### First Embodiment

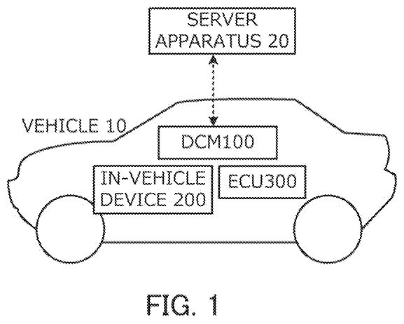

Outline of a vehicle system according to a first embodiment will be described with reference to FIG. 1. The vehicle system according to the present embodiment includes a vehicle 10 and a server apparatus 20.

The vehicle 10 is a connected car that has a function of communicating with an external network. The vehicle 10 includes a data communication module (DCM) 100, an in-vehicle device 200 and an electronic control unit (ECU) 300.

Note that while FIG. 1 illustrates a single ECU 300, the vehicle 10 may include a plurality of ECUs 300.

The DCM 100 is a device that performs wireless communication with the external network. The DCM 100 functions as a gateway for connecting components (hereinafter, vehicle components) provided at the vehicle 10 to the external network. For example, the DCM 100 provides access to the external network, to the in-vehicle device 200 and the ECUs 300 provided at the vehicle 10. This enables the in-vehicle device 200 and the ECUs 300 to communicate with an external apparatus connected to the network via the DCM 100.

The in-vehicle device 200 is a device (for example, a car navigation device) that provides information to passengers of the vehicle. The in-vehicle device 200 is also called a car navigation device, an infotainment device or a head unit. The in-vehicle device 200 enables navigation and entertainment to be provided to passengers of the vehicle. The in-vehicle device 200 may download traffic information, road map data, music, a moving image, and the like, via the DCM 100.

The server apparatus 20 is an apparatus that provides information to the vehicle 10. In the present embodiment, the server apparatus 20 provides to the vehicle 10, speech data to be utilized when the DCM 100 gives a speech guidance. Note that the server apparatus 20 may also serve as an apparatus that provides other information (such as, for example, traffic information and information related to infotainment) to the vehicle 10.

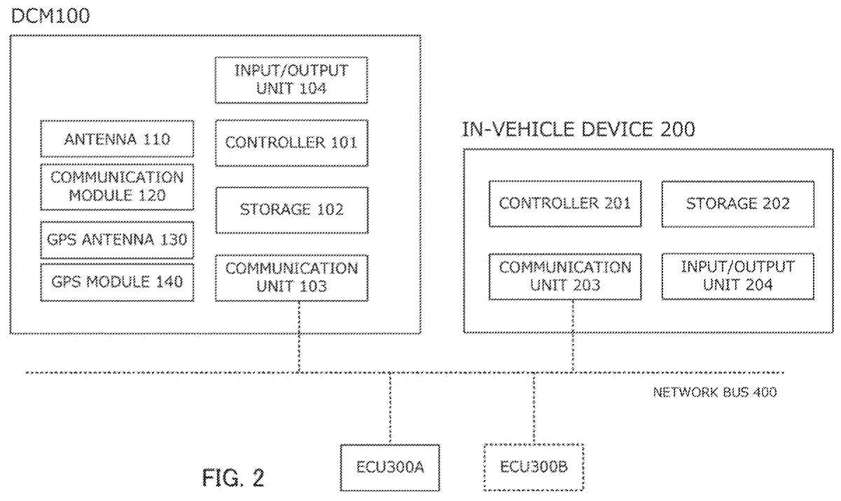

FIG. 2 is a view for explaining components of the vehicle 10 according to the present embodiment. The vehicle 10 according to the present embodiment includes the DCM 100, the in-vehicle device 200 and a plurality of ECUs 300A, 300B, . . . (hereinafter, collectively referred to as an ECU 300).

The ECU 300 may include a plurality of ECUs that control different vehicle components. Examples of the plurality of ECUs can include, for example, a body ECU, an engine ECU, a hybrid ECU, a power train ECU, and the like. Further, the ECU 300 may be divided on a function basis. For example, the ECU 300 may be divided into an ECU that executes a security function, an ECU that executes an autonomous parking function, and an ECU that executes a remote control function.

The DCM 100 includes an antenna 110, a communication module 120, a GPS antenna 130, a GPS module 140, a controller 101, a storage 102, a communication unit 103 and an input/output unit 104.

The antenna 110 is an antenna element that inputs/outputs a wireless signal. In the present embodiment, the antenna 110 complies with mobile communication (for example, mobile communication such as 3G, LTE and 5G). Note that the antenna 110 may include a plurality of physical antennas. For example, in a case where mobile communication utilizing a high-frequency radio wave such as a microwave and a millimeter wave is performed, a plurality of antennas may be arranged in a dispersed manner to achieve stable communication.

The communication module 120 is a communication module for performing mobile communication.

The GPS antenna 130 is an antenna that receives a positioning signal transmitted from a navigation satellite (also referred to as a GNSS satellite).

The GPS module 140 is a module that calculates position information on the basis of a signal received by the GPS antenna 130.

The controller 101 is an arithmetic unit that implements various kinds of functions of the DCM 100 by executing a predetermined program. The controller 101 may be, for example, implemented by a CPU, or the like.

The controller 101 executes functions of mediating communication to be performed between the external network and components (vehicle components) provided at the vehicle 10. For example, in a case where a certain vehicle component requires to communicate with the external network, the controller 101 executes a function of relaying data transmitted from the vehicle component to the external network. Further, the controller 101 executes a function of receiving data transmitted from the external network and transferring the data to an appropriate vehicle component.

Still further, the controller 101 can execute functions specific to the own apparatus. For example, the controller 101 is configured to be able to execute a monitoring function and a call function of a security system and can make a security notification, an emergency notification, or the like, on the basis of a trigger occurring inside the vehicle.

The storage 102 is a memory device including a main memory and an auxiliary memory. In the auxiliary memory, an operating system (OS), various kinds of programs, various kinds of tables, and the like, are stored, and each function that matches a predetermined purpose as will be described later can be achieved by the programs stored therein being loaded to the main memory and executed.

The communication unit 103 is an interface unit for connecting the DCM 100 to an in-vehicle network. In the present embodiment, a plurality of vehicle components including the in-vehicle device 200 and the ECU 300 are connected to each other via a bus 400 of the in-vehicle network. Examples of standards of the in-vehicle network can include, for example, a controller area network (CAN). Note that in a case where the in-vehicle network utilizes a plurality of standards, the communication unit 103 may include a plurality of interface devices in accordance with standards of communication destinations. Examples of the communication standards can also include, for example, Ethernet (registered trademark) as well as the CAN.

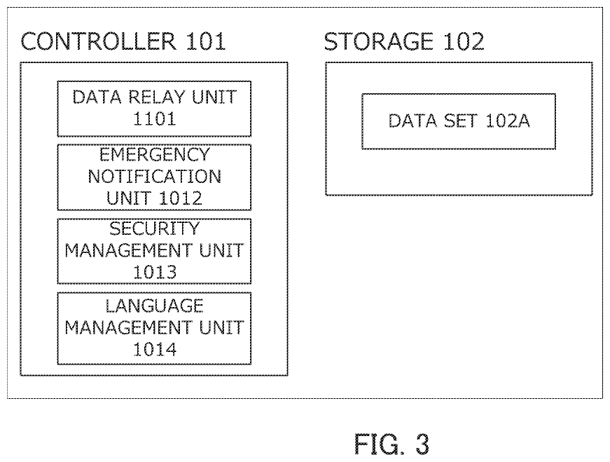

Functions to be executed by the controller 101 will be described next. FIG. 3 is a schematic view for explaining functional modules of the controller 101 and data stored in the storage 102. The functional modules of the controller 101 can be implemented by the controller 101 executing programs stored in a storage unit such as a ROM.

A data relay unit 1011 relays data to be transmitted/received between vehicle components. For example, the data relay unit 1011 performs processing of receiving a message sent by a first apparatus connected to the in-vehicle network and transferring the message to a second apparatus connected to the in-vehicle network as necessary. The first apparatus and the second apparatus may be ECUs 300 or may be other vehicle components.

Further, in a case where the data relay unit 1011 receives a message addressed to the external network from a vehicle component, the data relay unit 1011 relays the message to the external network. Still further, the data relay unit 1011 receives data transmitted from the external network and transfers the data to an appropriate vehicle component.

An emergency notification unit 1012 makes an emergency notification to an operator outside the vehicle in a case where an abnormal situation occurs in the vehicle 10. Examples of the abnormal situation can include occurrence of a traffic accident and a vehicle failure. The emergency notification unit 1012, for example, starts connection to the operator so that passengers of the vehicle can talk with the operator in a case where a predetermined trigger such as depression of a call button provided inside the vehicle and expansion of an air bag occurs. Note that upon emergency notification, the emergency notification unit 1012 may transmit the position information on the vehicle to the operator. In this case, the emergency notification unit 1012 may acquire the position information from the GPS module 140. The emergency notification unit 1012 can output a speech guidance by utilizing speech data which will be described later.

A security management unit 1013 performs security monitoring processing. The security management unit 1013, for example, detects that the vehicle is unlocked through a procedure that is not a normal procedure, on the basis of data received from the ECU 300 that controls an electronic lock of the vehicle and transmits a security notification to a predetermined apparatus. Note that the security notification may include the position information on the vehicle. In this case, the security management unit 1013 may acquire the position information from the GPS module 140. In a case where the security management unit 1013 determines that a problem occurs in security of the own vehicle, the security management unit 1013 may acquire the position information and may periodically transmit the acquired position information to an external apparatus designated in advance. The security management unit 1013 can also output a speech guidance in a similar manner to the emergency notification unit 1012.

A language management unit 1014 manages speech data to be utilized by the DCM 100. Each functional module provided at the DCM 100 can give a speech guidance using the speech data stored in the storage 102.

Meanwhile, in a case where the vehicle 10 is sold (resold) across countries and regions, a case occurs where the language to be utilized by the user does not match the language of a speech to be provided by the DCM 100. Thus, in a case where the language to be utilized by the user differs from the language of a speech to be provided by the DCM 100, the language management unit 1014 acquires speech data corresponding to an appropriate language from the server apparatus 20 and resets the language of the speech guidance. This enables an appropriate speech guidance to be provided even in a case where the vehicle 10 moves to a country or a region that are not planned at the beginning.

The storage 102 stores a data set 102A.

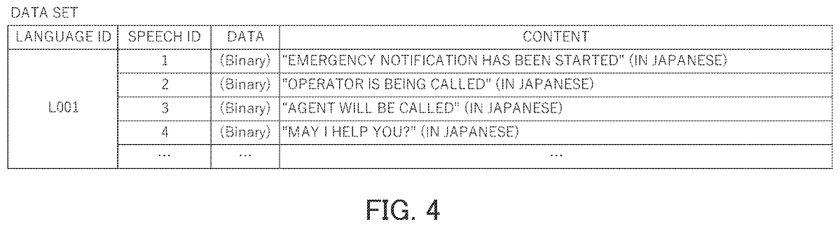

The data set 102A is an aggregate of speech data to be utilized when the DCM 100 gives a speech guidance. FIG. 4 illustrates an example of the data set 102A. The data set 102A includes a plurality of records including a language ID, a speech ID and binary data. The language ID is an identifier of a language (for example, Japanese). The storage 102 stores only the data set 102A corresponding to a single language. The speech ID is an identifier allocated to each speech. The binary data is a body of the speech data. As illustrated in FIG. 4, a plurality of pieces of speech data corresponding to a plurality of guidances to be provided by the DCM 100 are stored in the data set 102A.

The communication unit 103 is an interface unit for connecting the DCM 100 to the in-vehicle network. In the present embodiment, a plurality of vehicle components including the ECU 200 are connected to each other via a bus 400 of the in-vehicle network. Examples of standards of the in-vehicle network can include, for example, a controller area network (CAN). Note that in a case where the in-vehicle network utilizes a plurality of standards, the communication unit 103 may include a plurality of interface devices in accordance with standards of communication destinations. Examples of the standards can also include, for example, Ethernet (registered trademark) as well as the CAN.

The input/output unit 104 is a unit that inputs/outputs information. More specifically, the input/output unit 104 includes a help button to be depressed in emergency circumstances, a microphone, a speaker, and the like. In the present embodiment, the input/output unit 104 does not have a screen.

Note that the DCM 100 may be able to operate independently of other components provided at the vehicle 10. For example, an auxiliary battery may be incorporated into the DCM 100, and the DCM 100 may be able to independently operate without an external power supply. Such a configuration enables an emergency notification, or the like, to be made even in a case where an operation failure (such as, for example, a failure in power feeding) occurs in other components of the vehicle 10 due to a traffic accident, or the like.

Returning to FIG. 2, the in-vehicle device 200 will be described.

The in-vehicle device 200 is a device that provides information to passengers of the vehicle 10 and is also called a car navigation system, an infotainment system or a head unit. The in-vehicle device 200 can provide navigation or entertainment to passengers of the vehicle. Further, the in-vehicle device 200 may have a function of downloading traffic information, road map data, music, a moving image, and the like, by communication with an external network of the vehicle 10. Still further, the in-vehicle device 200 may be a device that coordinates with a smartphone, or the like.

Further, the in-vehicle device 200 also functions as a front end of the DCM 100. For example, when the DCM 100 executes predetermined processing (for example, emergency notification), the in-vehicle device 200 inputs/outputs information related to the processing (for example, displays a calling status of the operator). Further, the in-vehicle device 200 acquires designation of the language, or the like, when the DCM 100 changes the language of the speech guidance.

The in-vehicle device 200 can be constituted with a computer. In other words, the in-vehicle device 200 can be constituted as a computer including a processor such as a CPU and a GPU, a main memory such as a RAM and a ROM, and an auxiliary memory such as an EPROM, a hard disk drive and a removable medium. An operating system (OS), various kinds of programs, various kinds of tables, and the like, are stored in the auxiliary memory, and each function that matches a predetermined purpose as will be described later can be implemented by the programs stored in the auxiliary memory being executed. However, some or all of the functions may be implemented by a hardware circuit such as an ASIC and an FPGA.

The in-vehicle device 200 includes a controller 201, a storage 202, a communication unit 203, and an input/output unit 204.

The controller 201 is a unit configured to manage control of the in-vehicle device 200. The controller 201 is constituted with, for example, information processing units such as a central processing unit (CPU) and a graphics processing unit (GPU).

The controller 201 provides information to passengers of the vehicle. Examples of the information to be provided include, for example, traffic information, navigation information, music, a video, radio broadcasting, digital TV broadcasting, and the like. The controller 201 outputs information via the input/output unit 204.

The storage 202 is a unit configured to store information and is constituted with storage media such as a RAM, a magnetic disk, a flash memory, and the like. In the storage 202, various kinds of programs to be executed at the controller 201, data to be utilized by the programs, and the like, are stored.

The communication unit 203 is a communication interface that connects the in-vehicle device 200 to the bus 400 of the in-vehicle network.

The input/output unit 204 is a unit configured to accept input operation performed by the user and present information to the user. More specifically, the input/output unit 204 is constituted with a touch panel and a control unit thereof, and a liquid crystal display and a control unit thereof. In the present embodiment, the touch panel and the liquid crystal display are constituted as one touch panel display. Further, the input/output unit 204 may include a speaker, and the like, for outputting a speech.

The ECU 300 will be described next.

The ECU 300 is an electronic control unit that controls components provided at the vehicle 10. The vehicle 10 may include a plurality of ECUs 300. The plurality of ECUs 300, for example, control components of different systems such as an engine system, an electronic equipment system and a power train system. The ECU 300 has a function of generating a specified message and periodically transmitting/receiving the message via the in-vehicle network.

Further, the ECU 300 can provide a predetermined service by communicating with the external network via the DCM 100. Examples of the predetermined service can include, for example, a remote service (for example, a remote air conditioning service), a security monitoring service, a service of coordinating with a smart home, an autonomous parking service (a service of autonomously traveling between a parking slot and an entrance of a building), and the like.

The ECU 300 can be constituted as a computer including a processor such as a CPU and a GPU, a main memory such as a RAM and a ROM, and an auxiliary memory such as an EPROM, a disk drive and a removable medium in a similar manner to the DCM 100.

The network 400 is a communication bus that constitutes the in-vehicle network. Note that while one bus is illustrated in the present example, the vehicle 10 may include two or more communication buses. A plurality of communication buses may be connected to each other by the DCM 100 or a gateway that puts the plurality of communication buses together.

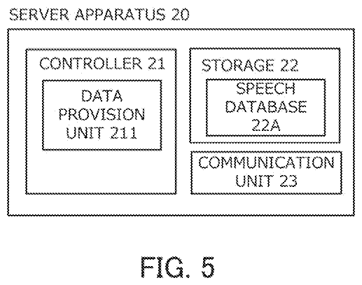

The server apparatus 20 will be described next. FIG. 5 is a schematic view of the server apparatus 20 in the first embodiment.

In the present embodiment, the server apparatus 20 provides a set of speech data corresponding to a predetermined language in response to a request from the DCM 100 (language management unit 1014). The server apparatus 20 may also serve as an apparatus that provides other information (such as, for example, traffic information and information related to navigation) to the DCM 100 and the in-vehicle device 200.

The server apparatus 20 can be constituted with a computer. In other words, the server apparatus 20 can be constituted as a computer including a processor such as a CPU and a GPU, a main memory such as a RAM and a ROM, and an auxiliary memory such as an EPROM, a hard disk drive and a removable medium.

The server apparatus 20 includes a controller 21, a storage 22 and a communication unit 23.

The controller 21 is an arithmetic device that manages control to be performed by the server apparatus 20. The controller 21 can be implemented by an arithmetic processing device such as a CPU.

The controller 21 includes a data provision unit 211 as a functional module. The functional module may be implemented by a stored program being executed by the CPU.

The data provision unit 211 acquires a set of speech data corresponding to a predetermined language from a speech database 22A which will be described later in response to a request from the DCM 100 (language management unit 1014) and provides the set of speech data to the DCM 100.

The storage 22 includes a main memory and an auxiliary memory. The main memory is a memory in which programs to be executed by the controller 21 and data to be utilized by the control program are expanded. The auxiliary memory is a device in which programs to be executed at the controller 21 and data to be utilized by the control program are stored.

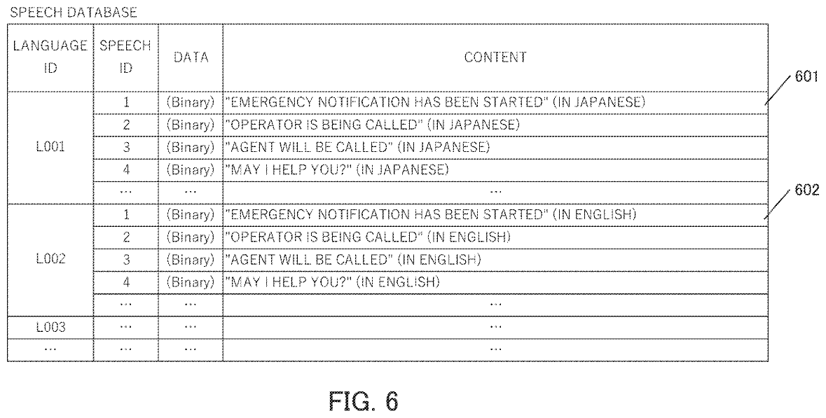

The speech database 22A is stored in the storage 22. The speech database 22A is a database that manages speech data to be utilized by the DCM 100 for each of a plurality of languages. FIG. 6 is a view for explaining a configuration of the speech database 22A. As illustrated in FIG. 6, a plurality of pieces of speech data corresponding to a plurality of language IDs (L001, L002, . . . ) are stored in the speech database 22A. The data provision unit 211 acquires a set of speech data corresponding to the language designated by the DCM 100 from the speech database 22A and transmits the set of speech data to the DCM 100.

The communication unit 23 is a communication interface for connecting the server apparatus 20 to a network. The communication unit 23 includes, for example, a network interface board and a wireless communication interface for wireless communication.

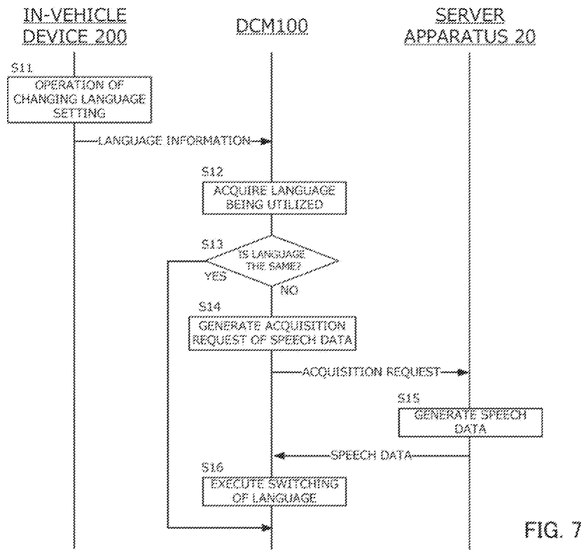

Processing of the DCM 100 changing the language of a speech guidance will be described next. FIG. 7 is a flowchart of processing to be executed by components included in a vehicle system according to the present embodiment. The illustrated processing is started in a case where the user of the vehicle performs operation of changing the language of the speech guidance.

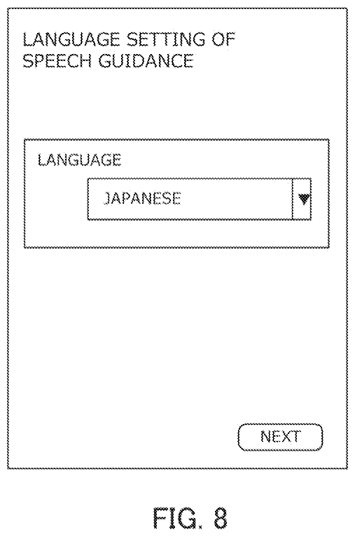

First, in step S11, the in-vehicle device 200 accepts operation of changing language setting. The in-vehicle device 200, for example, accepts operation of changing language setting via the screen as illustrated in FIG. 8. Note that while the illustrated screen is an example of a case where the in-vehicle device 200 functions as a front end of the DCM 100, the in-vehicle device 200 may be a device that is independent of the DCM 100, such as a car navigation device. In this case, language setting of the DCM 100 may be started by being triggered by change of language setting at the navigation device. In this case, the language of the speech guidance to be utilized by the DCM 100 is the same as the language set at the navigation device.

Note that the present step may be executed at a timing of initial setting of the vehicle 10 (setting to be performed by the user after purchase of the vehicle).

Information regarding the language after change is transmitted to the DCM 100.

In step S12, the DCM 100 (language management unit 1014) acquires the language that is currently being used at the own apparatus.

Then, in step S13, it is determined whether or not the language after change is the same as the language being used. In a case where a positive determination result is obtained in the present step, the processing is finished. In a case where a negative determination result is obtained in the present step, the processing transitions to step S14.

In step S14, the language management unit 1014 generates an acquisition request of speech data and transmits the acquisition request to the server apparatus 20 (data provision unit 211). The request includes information for identifying the language after change.

Then, in step S15, the data provision unit 211 acquires a set of speech data corresponding to the requested language from the speech database 22A stored in the storage 22 and transmits the acquired speech data to the DCM 100.

In step S16, the language management unit 1014 updates speech data included in the data set 102A with the acquired speech data. As a result of this, the language of the speech guidance is changed.

As described above, the DCM 100 according to the first embodiment acquires speech data for giving a guidance from the server apparatus on the basis of the request from the user. This enables the language of the speech guidance to be switched to an arbitrary language.

In the present embodiment, instead of storing speech data corresponding to all languages in the DCM 100, only in a case where the language of the speech guidance differs from the language to be utilized by the user, necessary speech data is externally acquired. This can reduce capacity of the memory provided at the DCM 100, so that it is possible to contribute to reduction in manufacturing cost.

### Second Embodiment

In the first embodiment, the language after switching is designated by the user. In contrast, a second embodiment is an embodiment in which the language being utilized by the user is automatically determined and the language after switching is determined on the basis of a result of the determination.

In the second embodiment, the language management unit 1014 actively determines that the language being utilized by the user differs from the language set at the DCM 100 and suggests the user change of the language of the speech guidance.

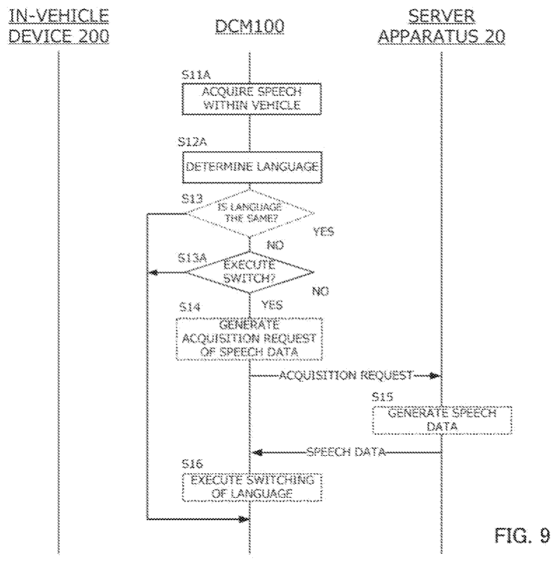

FIG. 9 is a flowchart of processing to be executed by components included in a vehicle system according to the second embodiment. Step similar to the step in the first embodiment is indicated with a dotted line, and description thereof will be omitted.

First, in step S11A, the DCM 100 (language management unit 1014) acquires a speech inside the vehicle 10. The speech inside the vehicle can be acquired using a microphone, or the like, included in the input/output unit 104.

Then, in step S12A, the language management unit 1014 analyzes the acquired speech to determine the language. For example, the language management unit 1014 determines that a conversation is held in English inside the vehicle. The language obtained as a result of the analysis becomes a candidate for the language after change.

In a case where the candidate language differs from the language of the speech guidance of the DCM 100, the processing transitions to step S13A.

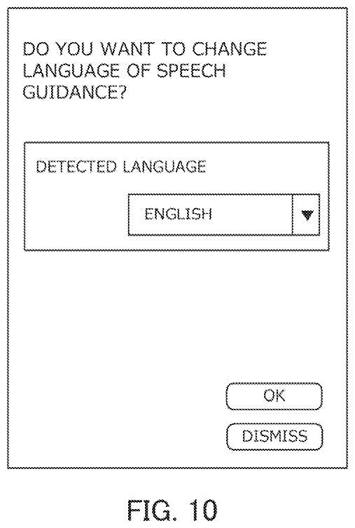

In step S13A, it is determined whether or not to execute switching of the language. In the present step, for example, switching of the language is suggested to the user via the input/output unit 104 or the in-vehicle device 200. For example, the screen as illustrated in FIG. 10 is output, and a response from the user is acquired. In a case where permission of the user can be obtained as a result of this, the processing transitions to step S14. In a case where permission cannot be obtained, the processing is finished.

Processing in step S14 and subsequent step is similar to that in the first embodiment.

As described above, in the second embodiment, change of the language of the speech guidance at the DCM 100 is suggested on the basis of the language of the speech detected inside the vehicle. This enables change of the language of the speech guidance without the user actively performing operation.

Note that the language detected from the speech inside the vehicle is not necessarily a native language of passengers of the vehicle 10. Thus, in a case where the proposal is not accepted in step S13A, the subsequent proposal (or a proposal to switch to the same language) may be stopped.

Further, the processing illustrated in FIG. 9 may be performed only upon initial setting of the vehicle 10. For example, the DCM 100 may encourage the user to make an utterance in a language that the user desires to set and may determine the language after change on the basis of the utterance.

### Third Embodiment

In the first and the second embodiments, a single language is set as the language after change. However, there is a case where it is not preferable to utilize a single language depending on a region in which the vehicle 10 travels, races or nationality of passengers of the vehicle 10. For example, such a case includes a case where a native language of the driver is different from a native language of a fellow passenger. In particular, in a case where the DCM 100 provides an emergency notification service, or the like, it is preferable to provide a speech guidance in a plurality of languages so that all the passengers can understand the guidance.

A third embodiment is an embodiment in which the server apparatus 20 generates speech data for giving a guidance in a plurality of languages to address this.

The third embodiment differs from the embodiments described above in that there are two or more types of languages to be determined by the language management unit 1014.

For example, in step S11 in the first embodiment, two or more types of languages may be designated. Further, the speech acquired in step S11A in the second embodiment may include two or more types of languages.

For example, the language management unit 1014 determines that “the user designates two languages of Japanese and English as the languages after change” or that “Japanese and English are detected from the speech inside the vehicle”.

An acquisition request to be transmitted from the DCM 100 to the server apparatus 20 includes designation of two or more languages (for example, Japanese and English).

Further, in the present embodiment, in step S15, the server apparatus 20 (data provision unit 211) generates speech data that gives a speech guidance in the designated two or more languages.

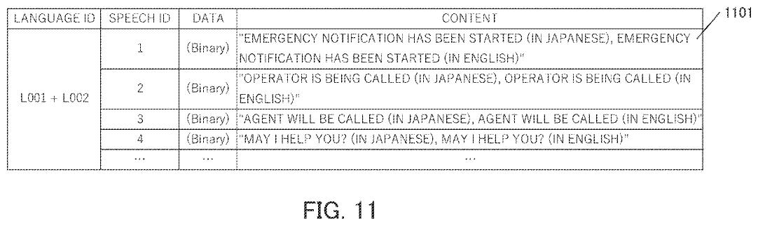

In step S15, the data provision unit 211 generates a set of speech data that gives a guidance in a plurality of languages by combining speech data included in the speech database 22A. For example, Japanese speech data indicated with reference numeral 601 in FIG. 6 and English speech data indicated with reference numeral 602 are combined to generate speech data that gives a guidance both in Japanese and English as indicated with reference numeral 1101 in FIG. 11. This processing is executed for each of a plurality of speech IDs. The generated speech data is transmitted to the DCM 100.

The DCM 100 updates the data set 102A stored in the storage 102 with such speech data. By this configuration, it is possible to constitute the DCM 100 that gives a speech guidance in a plurality of languages.

Note that while in the present embodiment, an example of two types of languages has been described, there may be three or more types of languages. Also in this case, target speech data can be obtained by the server apparatus 20 combining speech data corresponding to a plurality of languages.

### MODIFIED EXAMPLES

The above-described embodiments are merely examples, and the present disclosure can be changed and implemented as appropriate within a scope not deviating from the gist of the present disclosure.

For example, the processing and the units described in the present disclosure can be freely combined and implemented unless technical inconsistency occurs.

Further, while in the description of the embodiments, processing of changing language setting is started on the basis of the request from the user or the utterance of the user, the processing may be triggered by other events. For example, in a case where the DCM 100 gives a speech guidance in a first language, and there is no response to this from the user, processing of proposing to change the language setting to the user may be executed. Alternatively, processing of changing language setting to the default (such as English) may be executed.

In addition, the processing described as being performed by one device may be shared and executed by a plurality of devices. Alternatively, the processing described as being performed by different devices may be executed by one device. In a computer system, what hardware configuration (server configuration) realizes each function can be flexibly changed.

The present disclosure can also be realized by supplying a computer program including the functions described in the above embodiments to a computer and causing one or more processors included in the computer to read and execute the program. Such a computer program may be provided to the computer by a non-transitory computer-readable storage medium connectable to a system bus of the computer, or may be provided to the computer via a network. Examples of non-transitory computer readable storage media include: any type of disk such as a magnetic disk (floppy (registered trademark) disk, hard disk drive (HDD), etc.), an optical disk (CD-ROM, DVD disk, Blu-ray disk, etc.); and any type of medium suitable for storing electronic instructions, such as read-only memory (ROM), random access memory (RAM), EPROM, EEPROM, magnetic cards, flash memory, and optical cards.

What is claimed is:

1. An information processing apparatus comprising a controller configured to:
give a speech guidance to a user using first speech data corresponding to a first language;
determine that the user utilizes a language different from the first language; and
acquire second speech data corresponding to the language to be utilized by the user on a basis of a result of the determination.

2. The information processing apparatus according to claim 1, wherein
the information processing apparatus is mounted on a vehicle,
the information processing apparatus further comprising a communication module, and
the controller acquires the second speech data from an external apparatus via the communication module.

3. The information processing apparatus according to claim 2, wherein
in a case where operation of changing language setting is performed on a second information processing apparatus mounted on the vehicle, the controller acquires the second speech data corresponding to the language after change.

4. The information processing apparatus according to claim 3, wherein
the second information processing apparatus is a car navigation apparatus or a head unit apparatus including a display device.

5. The information processing apparatus according to claim 2, wherein
the controller further acquires a speech inside the vehicle and determines the language to be utilized by the user on a basis of the acquired speech.

6. The information processing apparatus according to claim 5, wherein
in a case where a language other than the first language is detected from the acquired speech, the controller suggests performing processing of switching the language of the speech guidance.

7. The information processing apparatus according to claim 5, wherein
in a case where there is no response to the speech guidance in the first language from the user, the controller suggests performing processing of switching the language of the speech guidance.

8. The information processing apparatus according to claim 1, wherein
the controller switches speech data to be used for the speech guidance from the first speech data to the second speech data after acquiring the second speech data.

9. The information processing apparatus according to claim 1, wherein
the user utilizes two or more languages, and
the controller acquires the second speech data for giving the speech guidance in the two or more languages.

10. The information processing apparatus according to claim 1, wherein
the information processing apparatus is mounted on a vehicle and is capable of providing a connected service independently of other components provided at the vehicle.

11. An information processing system comprising a first apparatus that gives a speech guidance to a user and a second apparatus that provides speech data to be used for the speech guidance,
wherein the first apparatus comprises a controller configured to:
give a speech guidance to the user using first speech data corresponding to a first language;
determine that the user utilizes a language different from the first language; and
acquire second speech data corresponding to the language to be utilized by the user from the second apparatus on a basis of a result of the determination.

12. The information processing system according to claim 11, wherein
the first apparatus is an apparatus mounted on a vehicle, and
the second apparatus is a server apparatus that manages the vehicle.

13. The information processing system according to claim 12, wherein
in a case where operation of changing language setting is performed on a third apparatus mounted on the vehicle, the controller acquires the second speech data corresponding to the language after change.

14. The information processing system according to claim 13, wherein
the third apparatus is a car navigation apparatus or a head unit apparatus including a display device.

15. The information processing system according to claim 12, wherein
the controller further acquires a speech inside the vehicle and determines the language to be utilized by the user on a basis of the acquired speech.

16. The information processing system according to claim 15, wherein
in a case where a language other than the first language is detected from the acquired speech, the controller suggests performing processing of switching a language of the speech guidance.

17. The information processing system according to claim 11, wherein
the controller switches speech data to be used for the speech guidance from the first speech data to the second speech data after acquiring the second speech data.

18. The information processing system according to claim 11, wherein
the user utilizes two or more languages, and
the second apparatus generates the second speech data for giving the speech guidance in the two or more languages.

19. The information processing system according to claim 11, wherein
the first apparatus is an apparatus that is mounted on a vehicle and is capable of providing a connected service independently of other components provided at the vehicle.

20. An information processing method comprising:
a step of giving a speech guidance to a user using first speech data corresponding to a first language;
a step of determining that the user utilizes a language different from the first language; and
a step of acquiring second speech data corresponding to the language to be utilized by the user on a basis of a result of the determination.
